(19) United States
(12) Patent Application Publication
(10) Pub. No.: US 2012/0176554 A1
(43) Pub. Date: Jul. 12, 2012

(54) REFLECTIVITY ABSORPTION SYSTEM FOR IDENTIFYING PRECIOUS OR SEMI-PRECIOUS MATERIALS AND ASSOCIATED METHODS

(76) Inventor: Cruz Bilbao, Anchorage, AK (US)

(21) Appl. No.: 13/292,860

(22) Filed: Nov. 9, 2011

Related U.S. Application Data
(60) Provisional application No. 61/411,827, filed on Nov. 9, 2010.
(60) Provisional application No. 61/441,122, filed on Feb. 9, 2011.

(51) Int. Cl. H04N 5/66; G01N 21/55

(52) U.S. Cl. 348/739; 356/445; 356/51; 356/72; 348/E05.133

(57) ABSTRACT

A reflectivity absorption system for identifying a target precious or semi-precious material can include a primary emitter, a detector and an output display. The primary emitter can emit an incident electromagnetic radiation at a primary wavelength which corresponds to an upper reflectivity of the target material. The detector is capable of detecting a reflected electromagnetic radiation at the primary wavelength. The reflected electromagnetic radiation derives from reflection of the incident electromagnetic radiation from a sample surface. The output display registers the reflected electromagnetic radiation in a viewable format. The sample surface can be identified as a target material by comparing the reflectivity response of the reflected radiation with a standard.

### RELATED APPLICATIONS

This application claims the benefit of U.S. Provisional Application No. 61/411,827, filed Nov. 9, 2010 and U.S. Provisional Application No. 61/441,122, filed Feb. 9, 2011, which are each incorporated herein by reference.

### BACKGROUND

Precious metals have a multitude of uses which range from catalysis and conductors, to drug delivery vehicles and coinage. Identifying locations of precious metals in mines and surface deposits has long been a challenge. Current methods involve visual inspection, panning, sifting, assaying, and the like. Often these methods can be time consuming and may be inaccurate. For example, mining operations in vertical wellbores and horizontal drilling systems routinely collect samples from locations as formation rock is removed. Samples from removed material are typically taken to a testing site for assaying. This can often involve hours or more of delay before determining whether precious metals have been located. In some drilling operations further drilling can damage precious metal recovery options such that delays in assaying result in delays in operation. Further, precious metal detection also involves various surface scanning technologies which range from spurious to respectable. However, each system has drawbacks ranging from sensitivity to poor accuracy.

### SUMMARY

A reflectivity absorption system for identifying a target precious or semi-precious material can include a primary emitter, a detector and an output display. More specifically, the primary emitter can be configured to emit an incident electromagnetic radiation at a primary wavelength. The primary wavelength corresponds to an upper reflectivity of the target precious or semi-precious material. The detector is capable of detecting a reflected electromagnetic radiation at the primary wavelength. The reflected electromagnetic radiation derives from reflection of the incident electromagnetic radiation from a sample surface. The output display is configured to register the reflected electromagnetic radiation in a viewable format. The system can optionally include variable radiation intensity for one or more emitted radiation wavelengths. These systems can be used in portable, handheld, wellbore deployable or stationary configurations. Further, the reflectivity absorption systems can identify exposed target materials in real-time.

A method of identifying a target precious or semi-precious material can also be provided which is based on reflectivity as utilized in the above-described system. The method can include directing an incident electromagnetic radiation at a sample surface. The incident electromagnetic radiation is at a primary wavelength which corresponds to an upper reflectivity of the target precious or semi-precious material. A reflected electromagnetic radiation can be collected from the sample surface. The method can further include registering a reflectivity response for the sample surface. Once the step of registering is accomplished, a candidate material can be identified as the target material by comparing the reflectivity response with a standard. Intensity of the incident radiation can be varied with time. Further, one or more additional radiation wavelengths can be emitted, reflected and registered to obtain additional advantages as described further herein. Thus, illumination and detection can be accomplished in a native location of the materials and need not be transferred to a remote location such as a lab.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic of a reflectivity absorption system in accordance with one embodiment.

FIG. 2A is a graph of reflectivity versus wavelength for gold, silver and aluminum.

FIG. 2B is a graph of reflectivity versus wavelength for platinum, palladium, rhodium and iridium.

FIG. 3 is a block diagram of a method for identifying precious or semi-precious materials in accordance with one embodiment.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### DEFINITIONS

In describing and claiming the present invention, the following terminology will be used.

The singular forms “a,” “an,” and “the” include plural referents unless the context clearly dictates otherwise. Thus, for example, reference to “an emitter” includes reference to one or more of such devices and reference to “registering” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, “reflectivity” and “reflectance” are interchangeably used and refer to the percentage of incident radiation which is reflected from a sample surface.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Reflectivity Absorption Systems

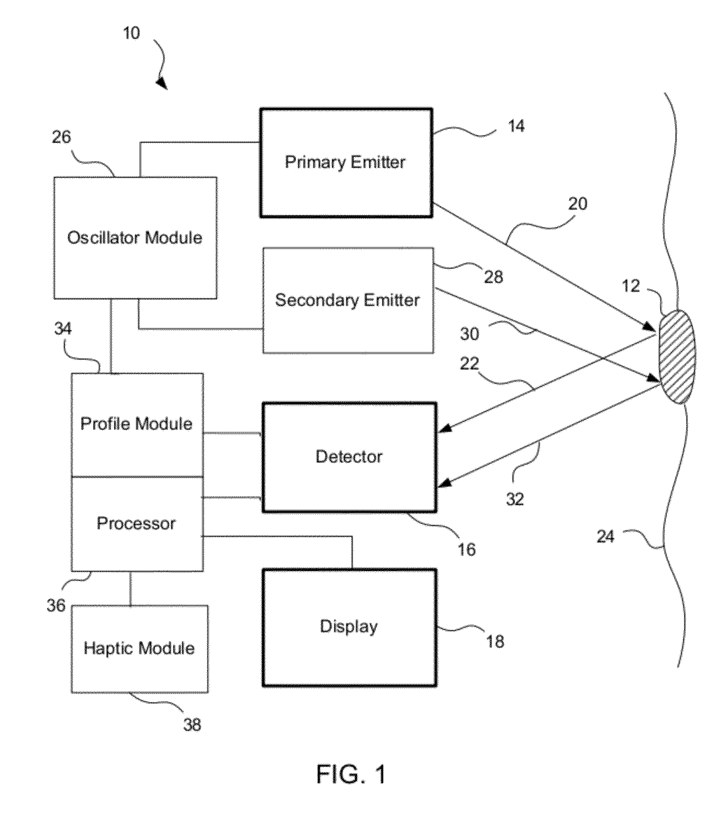

Referring to FIG. 1, a reflectivity absorption system 10 for identifying a target material 12 can include a primary emitter 14, a detector 16 and an output display 18. More specifically, the primary emitter 14 can be configured to emit an incident electromagnetic radiation 20 at a primary wavelength. The primary wavelength corresponds to an upper reflectivity of the target material 12. The detector 16 is capable of detecting a reflected electromagnetic radiation 22 at the primary wavelength. The reflected electromagnetic radiation 22 derives from reflection of the incident electromagnetic radiation 20 from a sample surface 24. The output display 18 is configured to register the reflected electromagnetic radiation 22 in a viewable format.

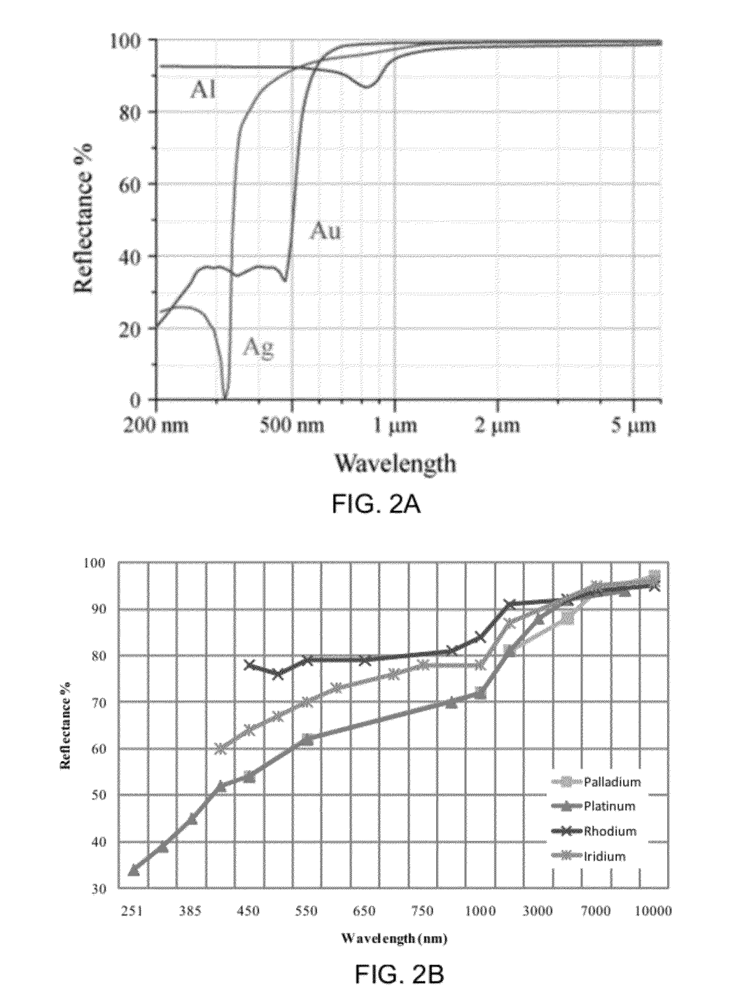

The primary emitter 14 can be any suitable emitter which produces a radiation at the desired wavelength. Non-limiting examples of suitable emitters can include light emitting diodes (LEDs), laser, or the like. In one aspect, the primary emitter is an LED. The primary emitter can be chosen to emit radiation at a specific wavelength or plurality of wavelengths (e.g. two, three, and up to narrow or full spectrum broadband). The primary wavelength is chosen to correspond to an upper reflectivity of the target material. Specifically, precious or semi-precious materials uniquely exhibit a spectral reflectivity curve where a dramatic increase in reflectivity occurs in the infrared range and especially in the near infrared range. The reflectivity within a region of infrared is substantially higher than most other materials. Referring to FIG. 2A, a steep increase in reflectivity is observed for gold (Au) at 480 nm to about 600 nm. From about 600 nm to about 1 μm, the reflectivity for gold is higher than most materials which can most often be below about 60%. Thus, an emitter with a primary wavelength from about 650 nm to about 1 μm can be desirable for gold. In one aspect, the primary wavelength is 850 μm, although other values can be used (e.g. 730 nm, 880 nm and 940 nm). Similarly, the target precious metal can be silver. In such case, it is noted that reflectivity of silver begins a dramatic increase around 310 nm up to about 500 nm. Thus, the primary wavelength for silver may be from about 500 nm to about 1 μm, although slightly lower or higher wavelengths can also be suitable if distinguishable from surrounding materials. Similar reflectivity curves are evident for other precious metals such as palladium, platinum, phodium and iridium as shown in FIG. 2B.

The upper reflectivity can be sufficiently high to distinguish reflected radiation signals from the target precious or semi-precious material over other surrounding materials. In one aspect, the upper reflectivity is greater than 95%. However, the absolute magnitude of the reflectivity may be less important than the relative difference between competing signals. Thus, it can be suitable to choose a primary wavelength which allows for a reflectivity difference sufficient to visually or computationally distinguish the target material. As a general guideline, this can be from about 5% to about 50%, depending on the particular test surface and conditions. The tolerance of this difference can be optionally adjustable to allow for increased or decreased sensitivity. For example, surfaces having a high amount of aluminum may need a higher tolerance (i.e. lower reflectivity difference) in order to trigger recognition of potential target precious or semi-precious material presence.

The emitter intensity can be varied and will affect the illumination range and reflected signal intensity. An increase in total emitter intensity can be achieved using higher power emitters and/or multiple emitters. For example, emitter power can typically range from about 1 μW to about 200 mW per emitter, although other powers can be used. Illumination range can vary from 0 feet up to about 4 feet up to 500 feet or more, although there is no technical range limitation and is only limited by the emitter output power and resolution of the detector. Incident radiation can be introduced at an angle and detected at an angle. Many materials also exhibit unique angle dependency of reflectivity which can be taken into account.

Referring again to FIG. 1, a complimentary detector 16 can be provided as part of the system 10 in order to receive reflected radiation 22 from a sample surface 24. The incident electromagnetic radiation 20 produced from the emitter 14 reflects from a sample surface 24 with a fraction of the incident radiation being reflected. The portion of radiation reflected is the reflected electromagnetic radiation 22. The fraction of radiation which is reflected is the reflectivity. Depending on the sample surface properties, the reflectivity varies accordingly. The reflected radiation can be detected using a suitable detector 16 which is sensitive to the primary wavelength. The detector can be any suitable detector such as, but not limited to, CCD, IR diode, and the like. In one aspect, the detector can be configured to detect and collect visible and infrared radiation. This can be useful in producing a visual video display. In one optional aspect, the detector can be an IR diode.

The reflectivity absorption system 10 can be further augmented by introduction of an oscillation module 26. The oscillation module 26 can be operatively connected to the primary emitter 14 and configured to oscillate an intensity of the incident electromagnetic radiation 20 over time. The oscillation of intensity can be sufficient to visually highlight or statistically distinguish potential target material from surrounding material. Due to the high reflectivity of such metals, oscillating the intensity between off and a full intensity can result in a glitter or flashing appearance. A full intensity can be the maximum output for the emitter or some fraction thereof, as long as the resulting signal is sufficient to be distinguishable. In one alternative, the secondary frequency can be maintained at constant intensity while the primary frequency can be oscillated. This can provide a background signal against which the primary frequency can be distinguished.

The oscillation module can be a simple electronic oscillator such as a relaxation oscillator or harmonic oscillator. The frequency of oscillation can be chosen based on the intended output format. For example, a low frequency oscillation (e.g. below about 15 Hz) may be desirable for visual video display and recognition while a high frequency oscillation may be useful for electronic computational assaying. Such oscillation can be matched with suitable emitters. It is noted that some emitters exhibit a delay or limit as to response times. If a sufficiently low frequency is chosen then this would not be a concern, although higher frequency choices can be accommodated by appropriate choice of an emitter capable of such oscillating power input. Pulsable emitters such as, but not limited to, INTEX a-CNC based IR LED emitters are available from Electro Optical Components.

A single oscillating emitter will result in the entire view oscillating as all reflected radiation, regardless of the surface properties will oscillate. In some cases it can be desirable to include a secondary emitter 28. This secondary emitter 28 can be provided as a constant background illumination (e.g. visible, second IR wavelength, etc) or as a second illumination reference point. For example, the secondary emitter 28 can be configured to emit a second incident electromagnetic radiation 30 at a secondary wavelength. The secondary wavelength can correspond to a lower reflectivity of the target material. As such, the surface 24 will form a secondary reflected electromagnetic radiation 32. It is noted that reflectivity is also a function of incident angles such that care should be taken to account for this. In one case the emitter(s) and detector(s) can be spatially adjacent so as to allow for substantially normal (i.e. perpendicular) incident and reflection from the surface.

In certain cases it can be desirable to operatively connect the secondary emitter 28 to the oscillation module 26. However, a second oscillation module can optionally be used. The oscillation module can be configured to oscillate a secondary intensity of the second incident electromagnetic radiation 30 in an interleaved intensity pattern with the incident electromagnetic radiation. As such, the surface can be substantially constantly illuminated by at least one emitter over time, while the incident radiation is oscillated between the two (or more) emitter sources. This can be beneficial in further distinguishing the precious or semi-precious materials from surrounding materials due to the unique reflectivity curves. Specifically, in circumstances where other high reflectivity materials are present, the use of multi-wavelength illumination will allow the target materials to stand out as the reflected radiation will have a substantial variation among the various wavelengths. The choice of specific wavelengths for each of the primary, secondary and optional additional wavelengths can be based on the desired target precious or semi-precious material and/or expected competing materials. In one option, the secondary wavelength can correspond to a lower reflectivity of the target material which is at least 20% lower than the upper reflectivity. In most cases, host rock and background material can have a difference in reflectivity of at least 10% to about 95%.

The detector can be common to receive reflected radiation from both emitters. Optionally, a dedicated detector or plurality of detectors can be provided for each frequency. This can allow for optimization of signals and/or modularization of the device. In yet another optional aspect, the detector can have a filter operatively associated therewith. A suitable filter can be provided to remove background noise or other wavelengths which may interfere with signal processing and/or visual identification. For example, blocking filters, band-pass filters, high-pass filters, low-pass filters, and the like can be used to exclude wavelengths outside a band of interest. Additional data processing elements may also be used to improve accuracy and sensitivity of received data. Furthermore, a polarizer and/or polarization filter can be used to polarize incoming radiation and/or incident radiation.

The system can optionally include a profile module 34 which can adjust emitter wavelengths, sensitivity, and/or signal output based on conditions and a desired target precious or semi-precious material. For example, optimal wavelengths and signal processing for gold detection for lost jewelry or coins may be slightly different from those for scanning for raw gold ore in a riverbed, although common settings may be used for both. As such, the profile module can store and apply different settings depending on use input and/or associated emitters. The profile module 34 can be connected to at least one of the oscillation module 26, the detector 16 and the display 18. Optionally, the profile module 34 can act as a central processor which analyzes and prepared raw data for display at the output display 18.

As one option, the system can be modular to allow for variation in the emitter. Thus, instead of having a dedicated internal profile module, the emitters can be user replaceable. For example, the primary emitter can be present in an emitter housing which is user detachable from the system. Similarly, the secondary emitter may be present in a secondary emitter housing which is user detachable from the system. A suitable releasable connector for power and optional data communication can be provided. The emitter housing can also include a suitable release mechanism which removably secures the emitter housing to a primary housing of the system. Non-limiting examples of release mechanisms can include latches, threads, snaps, detent, recessed lug and nut, and the like.

The system can optionally further include a processor 36 for comparing the incident and reflected electromagnetic radiation. This processor can be common with the optional profile module 34 or present as a separate unit. The processor 36 can be used, especially in multi-wavelength configurations, to compare reflectivities with a set threshold and/or with stored values for specific target materials.

The output display 18 is provided to communicate to a user information recorded about the surface properties. The output display 18 can optionally be integral with the primary emitter and the detector in a common housing. This configuration can be useful as a mobile and/or handheld device which is fully stand alone. Alternatively, the output display can be remotely connected to the detector via an output connection. For example, the output connection can be wired or wireless using any available and functional protocol. Non-limiting examples of such wireless communication can include Bluetooth, infrared, 802.11 standards, radio frequency (RF), laser light, optical, and the like. Wired connections can include, but are not limited to, optical fibers, copper wire, and the like.

The output display 18 can be configured for a variety of formats. For example, in many applications, the output display can be a video display. A video display offers convenient visual recognition by a user and correlation to a specific location to tag the target material. In some applications, non-video output can be provided in the form of a single output such as magnitude of signal or the like. In one option, the output display can be a numerical readout or bar graph. In another aspect, the output display may be an analog display (e.g. needle).

The specific implementation of the system can vary widely depending on the intended use and desired results. For example, an individual person seeking precious or semi-precious materials for weekend recreation may have different expected operational parameters than would be expected by a drilling exploration firm. Thus, in one alternative, the system can be a fully integrated mobile system which is handheld. In another configuration, the system can be configured for deployment down a wellbore. Such a device can include at least the emitter(s) and detector(s) on a deployable unit which can be lowered into a well. The deployable unit can be tethered with a support cable. Optionally, a power supply can be connected on-board the deployable unit or a power cable connected along with the support cable. Such a configuration can have on-board recording of information which is then later retrieved. For example, a connection port can be provided to connect the deployable unit to a computer after pulling the unit from the wellbore. Collected data can be transferred and then analyzed to identify candidate precious or semi-precious material locations. Typically, a depth indicator can be provided either on the deployable unit or at a surface location of the wellhead to measure depth as a function of time. This will allow collected data to be correlated to a specific location along the wellbore. In another option, the deployable unit can include a wired connection with a surface processor unit (e.g. profile module and/or processor) for data storage and/or analysis. Typically, in a deployable system, the output display is remote from the deployable unit. The output display can similarly be wirelessly connected or wired, or merely a computer monitor which displays information retrieved from the deployable unit. As such, depending on the connection choice, the output display can be real-time or delayed.

The system housing can be provided as a handheld unit which can be carried by a user. Alternatively, the system housing can be a head-mount system which can include a head strap. The emitter, detector and optional processing modules can be housed within the head-mount system and the display provided in a connected output display which can be carried or mounted (e.g. on a belt, jacket or stationary location). As such, the system can be portable and include a user holder. The user holder can be configured to allow a user to carry the system. For example, a handle or head-strap can be associated with the housing to allow a user to carry the system during use.

In one alternative, the processor can record the data collection history as a function of time. This information can be used to correlate remotely obtained data with physical locations and/or playback by a user and a later time. An optional GPS unit can be connected to the system to allow the system to be tracked at a surface location. For example, a GPS unit may be incorporated into a wellbore system which allows correlation of depth with GPS surface-collected information. The depth can be determined using any suitable technique such as, but not limited to, marked support cable, measuring dispensed cable into the wellbore, and the like. The deployable unit can also include proximity sensors or other features which allow the position within the wellbore to be determined.

In yet another option, the system can include a haptic feedback module 38. When candidate precious or semi-precious material is detected, the haptic feedback module can be activated to notify the user of such an event. This can help to avoid missed precious or semi-precious material due to inattention or oversight. The haptic feedback module 38 can be operatively connected to the detector 16 and/or processor 36. The haptic response can be triggered when the reflected electromagnetic radiation has a reflected intensity corresponding to the upper reflectivity or other preset condition. Typically, the haptic response can be vibration although other responses may be useful (e.g. temperature, pressure, etc).

Reflectivity Absorption Methods

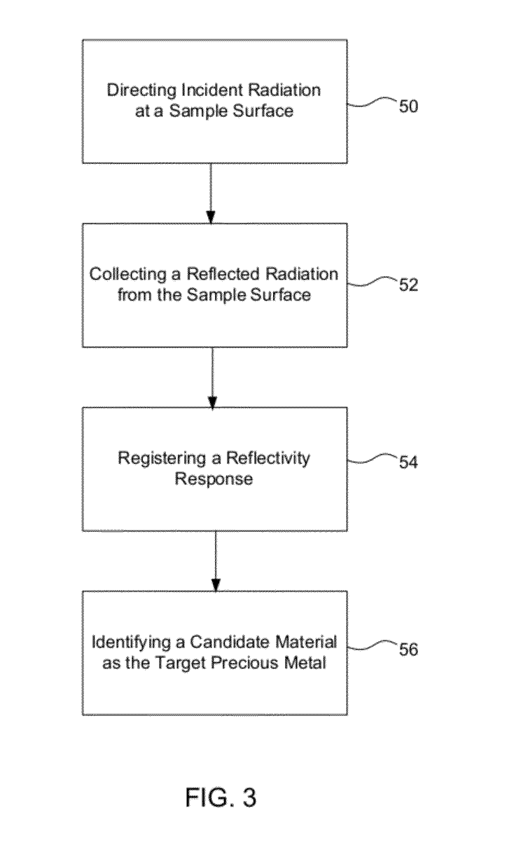

A method of identifying a target precious or semi-precious material can also be provided which is based on reflectivity as utilized in the above-described system. As generally illustrated in FIG. 3, the method can include directing an incident electromagnetic radiation at a sample surface 50. The incident electromagnetic radiation is at a primary wavelength which corresponds to an upper reflectivity of the target material. The incident electromagnetic radiation can optionally include a secondary wavelength which corresponds to a lower reflectivity of the gold material. A reflected electromagnetic radiation can be collected 52 from the sample surface. This can include detecting the radiation via a suitable detector as previously described. The method can further include registering a reflectivity response for the sample surface 54. Registering can include displaying the reflectivity response in a viewable format (e.g. video, numerical, analog, etc). Alternatively, the registering can include storing reflectivity response and/or data for the reflected electromagnetic radiation. Once the step of registering is accomplished, the method further includes identifying a candidate material as the target material 56 by comparing the reflectivity response with a standard. This identification step can be done by a user or via a computational device (e.g. a processor). The standard for comparison can be a visual brightness, flashing of the image, and/or a statistically significant data response in reflectivity and/or the response profile. Thus, in some cases, the standard can be a stored value for the target material and the identification is made by a processor.

As mentioned, the method can be applied to a variety of exploratory and/or assay scenarios. In one aspect, the sample surface can be an internal surface of a non-cased wellbore. Notably, typical assay methods for vertical drilling include preserving a core sample using a coring drill bit. In this manner, the core material is preserved in a cylindrical solid piece. Drilling with a core bit is slower and more expensive than direct drilling using a conventional drilling bit. With these reflectivity methods, conventional drilling can be done without preserving a core sample. As such, exploratory wellbores can be quickly drilled and then assayed using the reflectivity-based methods described herein.

These methods are capable of locating surface exposed precious or semi-precious materials, or such materials which are visible through a medium which is transparent to the incident radiation. Typically, water is transparent to most infrared wavelengths and can be used up to several inches or several feet if the emitter and detector combination has sufficient power and resolution. In another aspect, the sample surface can be an excavated mine wall. In this application, the method can allow for substantially real-time determination of the presence of precious or semi-precious materials in exposed rock. Further, the method can be performed along an exposed geological feature. Non-limiting examples of geological features can include riverbeds, cliff faces, outcrops, mine surfaces, and the like. In yet another aspect, a mining equipment operator can be associated with the system to notify of potential locations of target materials. For example, a haptic or visual device can be triggered when target material is detected so that more careful inspection can be made before proceeding with excavation. Also, the sample surface can be tailings or other material removed from excavation operations. Regardless, the methods and system can be highly useful in providing results for materials when in their native location and without need for transport to a remote location (e.g. mine surface, assay lab, etc.).

The sample surface can be illuminated via incident radiation at a single wavelength or multiple wavelengths. For example, the illumination and corresponding reflectivity response can be a two frequency response or can include at least three frequencies. Additional frequencies can provide additional reference points to compare with a known or stored standard which is representative of the target material. This can increase accuracy and sensitivity of the method. In one alternative aspect, the incident electromagnetic radiation is broadband. In this case, the step of registering can include matching the reflectivity response to a broadband reflectivity curve of the target material.

The multiple frequency reflectivity can be a broadband spectrum collected over numerous or continuous frequencies. For example, a selected band of frequencies can be chosen where spectral reflectivity responses for the target material are numerically distinguishable from other materials. In the case of gold such a selected band can have a lower bound from about 200 nm to about 480 nm and an upper bound from about 510 nm to about 1 μm. Similarly, a selected band for silver can have a lower bound from about 200 nm to about 320 nm and an upper bound from about 400 nm to about 1 μm. Silver also has a distinct dip at about 350 nm which can be targeted as a marker to distinguish silver from surrounding materials. Further, several frequencies can be chosen and reflectivities compared to the stored values for the target material. An optionally adjustable tolerance can be set to allow for sensitivity adjustments to compensate for non-ideal conditions (i.e. partially obscured materials, interfering materials, etc). Further, by combining reflectivity measurements over discrete spatial regions, an approximation of target material content can be calculated. This can be accomplished by an additional processing module or element which selects high density regions of the reflectivity response and calculates the surface percentage of reflectivity which matches the precious or semi-precious material. Methods such as edge detection algorithms (e.g. Gaussian and Laplace edge detection), finite element analysis, and the like can be used to identify sample regions. Alternatively, the images can be pixilated and regions analyzed by a straight count of high reflectivity pixels (i.e. statistically high intensity) versus lower intensity pixels.

Although gold and silver are exemplified throughout, other precious and semi-precious metals can also be similarly identified. Specifically, other precious metals can include platinum group elements such as platinum, palladium, ruthenium, rhodium, osmium, and iridium. In one aspect, the target precious metal can be palladium or platinum. Other semi-precious metals can include copper, lead, zinc, and alloys thereof. Further, precious materials such as gemstones (e.g. diamonds, emeralds, sapphire, and the like) can also be detected by their respective unique reflectivity patterns or values at various wavelengths. These materials also exhibit substantial variation which can be detected, especially using multi-wavelength illumination. Reflectivity data for these precious metals is shown in FIG. 2B. For example, platinum varies from about 40% reflectivity at 300 nm to about 73% at 1 μm. Similarly, palladium varies from about 54% at 450 nm up to about 81% at 2 μm. Thus, the response data can be quantitatively compared with stored values for each metal at specific frequencies.

Further, the intensity of the incident radiation can be varied with time such as in an oscillating pattern. When multiple frequencies are oscillated or varied with time, the incident radiation can also be interleaved so as to provide substantially constant illumination.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A reflectivity absorption system for identifying a target precious or semi-precious material, comprising:
a) a primary emitter configured to emit an incident electromagnetic radiation at a primary wavelength, said primary wavelength corresponding to an upper reflectivity of the target material;
b) a detector capable of detecting a reflected electromagnetic radiation at the primary wavelength, said reflected electromagnetic radiation deriving from reflection of the incident electromagnetic radiation from a sample surface; and
c) an output display configured to register the reflected electromagnetic radiation in a viewable format.

2. The system of claim 1, wherein the primary emitter is an LED.

3. The system of claim 1, wherein the primary wavelength is infrared.

4. The system of claim 3, wherein the primary wavelength is from about 650 nm to about 1 μm.

5. The system of claim 3, wherein the primary wavelength is 850 μm.

6. The system of claim 1, wherein the upper reflectivity is greater than 95%.

7. The system of claim 1, wherein the target material is at least one of gold and silver.

8. The system of claim 1, wherein the detector is a CCD.

9. The system of claim 8, wherein the detector is configured to detect visible and infrared radiation.

10. The system of claim 1, wherein the detector is an IR diode.

11. The system of claim 1, wherein the primary emitter is present in an emitter housing which is user detachable from the system.

12. The system of claim 1, further comprising an oscillation module operatively connected to the primary emitter and configured to oscillate an intensity of the incident electromagnetic radiation over time.

13. The system of claim 12, wherein the oscillation module is configured to oscillate the intensity between off and a full intensity.

14. The system of claim 12, further comprising a secondary emitter configured to emit a second incident electromagnetic radiation at a secondary wavelength, said secondary wavelength corresponding to a lower reflectivity of the target material.

15. The system of claim 14, wherein the secondary emitter is operatively connected to the oscillation module and the oscillation module is further configured to oscillate a secondary intensity of the second incident electromagnetic radiation in an interleaved intensity pattern with the incident electromagnetic radiation.

16. The system of claim 14, wherein the secondary wavelength corresponds to the lower reflectivity of the target material which is at least 20% lower than the upper reflectivity.

17. The system of claim 14, wherein the secondary emitter is present in a secondary emitter housing which is user detachable from the system.

18. The system of claim 1, further comprising a processor for comparing the incident electromagnetic radiation and the reflected electromagnetic radiation.

19. The system of claim 1, wherein the output display is integral with the primary emitter and the detector in a common housing.

20. The system of claim 1, wherein the output display is remotely connected to the detector via an output connection.

21. The system of claim 20, wherein the output connection is wired or wireless.

22. The system of claim 1, wherein the output display is a video display.

23. The system of claim 1, wherein the output display is a numerical readout.

24. The system of claim 1, wherein the output display is an analog display.

25. The system of claim 1, wherein the system is configured for deployment down a wellbore, and further comprises a depth indicator.

26. The system of claim 1, further comprising a haptic feedback operatively connected to the detector and configured to provide a haptic response when the reflected electromagnetic radiation has a reflected intensity corresponding to the upper reflectivity.

27. The system of claim 26, wherein the haptic response is vibration.

28. A method of identifying a target precious or semi-precious material, comprising:
a) directing an incident electromagnetic radiation at a sample surface, said incident electromagnetic radiation at a primary wavelength which corresponds to an upper reflectivity of the target material;
b) collecting a reflected electromagnetic radiation from the sample surface;
c) registering a reflectivity response for the sample surface; and
d) identifying a candidate material as the target material by comparing the reflectivity response with a standard.

29. The method of claim 28, wherein the sample surface is an internal surface of a non-cased wellbore.

30. The method of claim 28, wherein the sample surface is an excavated mine wall.

31. The method of claim 28, wherein the sample surface is an exposed geological feature.

32. The method of claim 28, wherein the incident electromagnetic radiation is produced by an LED.

33. The method of claim 28, wherein the incident electromagnetic radiation is broadband.

34. The method of claim 28, wherein the primary wavelength is infrared.

35. The method of claim 28, wherein the registering includes matching the reflectivity response to a broadband reflectivity curve of the target material.

36. The method of claim 28, wherein the reflectivity response is a single frequency reflectivity.

37. The method of claim 28, wherein the reflectivity response is a multiple frequency reflectivity.

38. The method of claim 37, wherein the reflectivity response is a two frequency response.

39. The method of claim 37, wherein the multiple frequency reflectivity is at least three frequencies.

40. The method of claim 28, wherein the registering includes storing reflectivity data for the reflected electromagnetic radiation.

41. The method of claim 28, wherein the registering includes visually displaying reflectivity data.

42. The method of claim 28, wherein the standard is a stored value for the target material, and the identifying the candidate material is performed by a processor.

43. The method of claim 28, wherein the identifying the candidate material includes visually noting the reflectivity response.
